(19) United States
(12) Patent Application Publication
(10) Pub. No.: US 2024/0369401 A1
(43) Pub. Date: Nov. 7, 2024

(54) EVENT DETECTION DEVICE, EVENT DETECTION SYSTEM, AND EVENT DETECTION METHOD

(71) Applicant: NEC Corporation, Minato-ku, Tokyo (JP)

(72) Inventor: Tadayuki IWANO, Tokyo (JP)

(73) Assignee: NEC Corporation, Minato-ku, Tokyo (JP)

(21) Appl. No.: 18/681,696

(22) PCT Filed: Aug. 20, 2021
(86) PCT No.: PCT/JP2021/030521

§ 371 Date: Feb. 6, 2024

(51) Int. Cl. G01H 9/00; G01D 5/353; G01K 11/32

(52) U.S. Cl. CPC G01H 9/004; G01D 5/35358; G01K 11/32

(57) ABSTRACT

Provided is an event detection device or the like with which it is possible to provide different services, using a single optical fiber cable, for each segment of the optical fiber cable. This event detection device includes: a sensing data acquisition unit for executing optical fiber sensing using an optical fiber cable, thereby acquiring sensing data; a first detection unit for detecting the occurrence of a first event in a first segment of the optical fiber cable using first sensing data that is based on first rearward-scattered light generated in the first segment, from among the sensing data; and a second detection unit for detecting the occurrence of a second event in a second segment of the optical fiber cable using second sensing data that is based on second rearward-scattered light generated in the second segment, from among the sensing data.

### TECHNICAL FIELD

The present invention relates to an event detection device and the like.

### BACKGROUND ART

A technology for detecting occurrence of a predetermined event around an optical fiber cable by executing fiber optic sensing is known. For example, PTL 1 discloses a technology for detecting occurrence of an event, such as a person holding and shaking a fence, by detecting vibration by using an optical fiber cable installed on the fence. A technology described in PTL 2 is also known as a related art.

Each section of a single optical fiber cable may be installed in a different form in the technology described in PTL 1. For example, one part of sections of a single optical fiber cable may be aerially installed, and another part of the sections of the single optical fiber cable may be installed underground (see paragraph [0030] and FIG. 1 in PTL 1).

Further, occurrence of an identical event is detected in sections of a single optical cable different from each other in the technology described in PTL 1 (see paragraph [0030] in PTL 1).

### CITATION LIST

### Patent Literature

PTL 1: International Application Publication No. WO 2020/166057

PTL 2: Japanese Unexamined Patent Application Publication No. 2010-127761

### SUMMARY OF INVENTION

### Technical Problem

However, occurrence of a different event for each section cannot be detected in sections of a single optical cable different from each other in the technology described in PTL 1. As a result, there is an issue with the technology described in PTL 1 that it is difficult to provide a different service based on fiber optic sensing for each section of a single optical fiber cable (may be hereinafter referred to as a “multi-service”).

An object of the present invention is to, in view of the aforementioned issue, provide an event detection device and the like that can provide a different service based on fiber optic sensing for each section of a single optical fiber cable.

### Solution to Problem

An event detection device according to the present invention includes: a sensing data acquisition means for acquiring sensing data by executing fiber optic sensing using an optical fiber cable; a first detection means for detecting occurrence of a first event in a first section of the optical fiber cable by using first sensing data in the sensing data, the first sensing data being based on first back scattering light generated in the first section; and a second detection means for detecting occurrence of a second event in a second section of the optical fiber cable by using second sensing data in the sensing data, the second sensing data being based on second back scattering light generated in the second section.

An event detection system according to the present invention includes: a sensing data acquisition means for acquiring sensing data by executing fiber optic sensing using an optical fiber cable; a first detection means for detecting occurrence of a first event in a first section of the optical fiber cable by using first sensing data in the sensing data, the first sensing data being based on first back scattering light generated in the first section; and a second detection means for detecting occurrence of a second event in a second section of the optical fiber cable by using second sensing data in the sensing data, the second sensing data being based on second back scattering light generated in the second section.

An event detection method according to the present invention includes: by a sensing data acquisition means, acquiring sensing data by executing fiber optic sensing using an optical fiber cable; by a first detection means, detecting occurrence of a first event in a first section of the optical fiber cable by using first sensing data in the sensing data, the first sensing data being based on first back scattering light generated in the first section; and, by a second detection means, detecting occurrence of a second event in a second section of the optical fiber cable by using second sensing data in the sensing data, the second sensing data being based on second back scattering light generated in the second section.

### Advantageous Effects of Invention

The present invention can provide an event detection device and the like that can provide a different service based on fiber optic sensing for each section of a single optical fiber cable.

### BRIEF DESCRIPTION OF DRAWINGS

FIG. 1 is a block diagram illustrating an event detection system according to a first example embodiment.

FIG. 2 is a diagram illustrating an installation example of an optical fiber cable in the event detection system according to the first example embodiment.

FIG. 3 is a block diagram illustrating an example of a detection unit in an event detection device according to the first example embodiment.

FIG. 4 is a block diagram illustrating an example of a customer system.

FIG. 5 is a block diagram illustrating a hardware configuration of the event detection device according to the first example embodiment.

FIG. 6 is a block diagram illustrating another hardware configuration of the event detection device according to the first example embodiment.

FIG. 7 is a block diagram illustrating another hardware configuration of the event detection device according to the first example embodiment.

FIG. 8 is a flowchart illustrating the operation of the event detection device according to the first example embodiment.

FIG. 9 is a block diagram illustrating an event detection system according to a second example embodiment.

FIG. 10 is a block diagram illustrating an example of a setting unit in an event detection device according to the second example embodiment.

FIG. 11 is a flowchart illustrating the operation of the event detection device according to the second example embodiment.

FIG. 12 is a block diagram illustrating an event detection device according to a third example embodiment.

FIG. 13 is a block diagram illustrating an event detection system according to the third example embodiment.

### EXAMPLE EMBODIMENT

Example embodiments of the present invention will be described in detail below with reference to accompanying drawings.

### First Example Embodiment

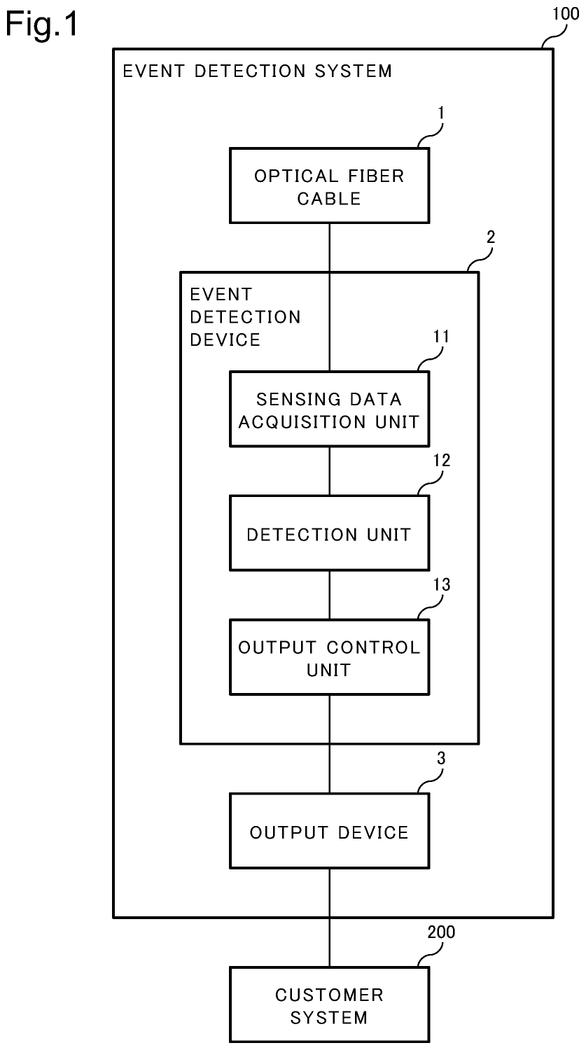

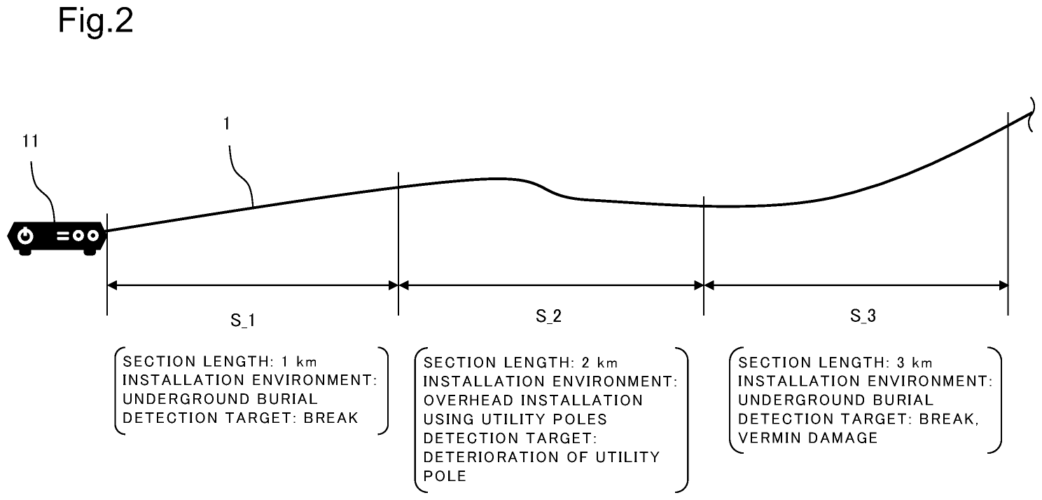

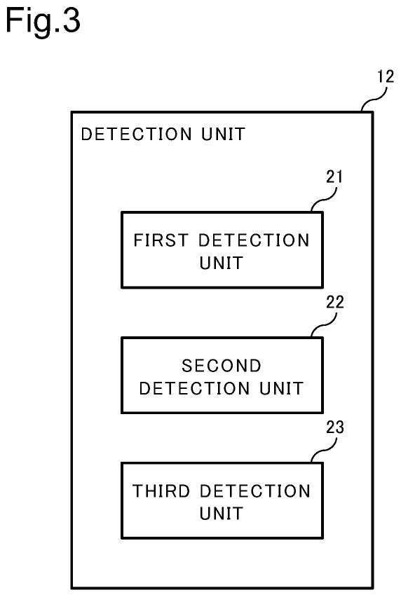

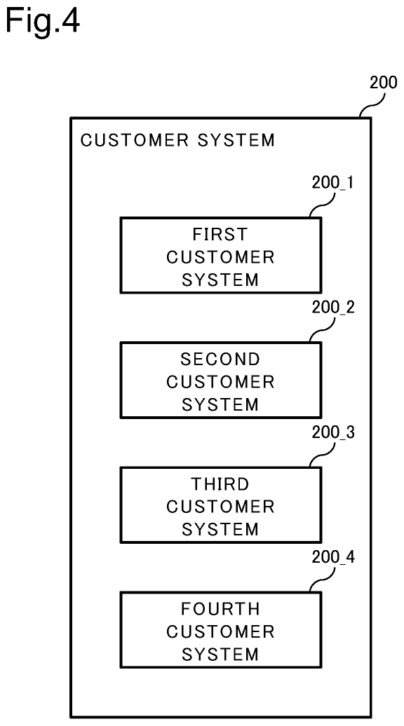

FIG. 1 is a block diagram illustrating an event detection system according to a first example embodiment. FIG. 2 is a diagram illustrating an installation example of an optical fiber cable in the event detection system according to the first example embodiment. FIG. 3 is a block diagram illustrating an example of a detection unit in an event detection device according to the first example embodiment. FIG. 4 is a block diagram illustrating an example of a customer system. The event detection system according to the first example embodiment will be described with reference to FIG. 1 to FIG. 4.

As illustrated in FIG. 1, the event detection system 100 includes an optical fiber cable 1, an event detection device 2, and an output device 3. The optical fiber cable 1 is optically connected to the event detection device 2. The event detection device 2 is connected to the output device 3 in a wired or wireless manner and is communicable with the output device 3. The output device 3 is connected to a customer system 200 through an unillustrated network and is communicable with the customer system 200.

The optical fiber cable 1 is used for fiber optic sensing. More specifically, the optical fiber cable 1 is used for distributed fiber optic sensing (DFOS). Data acquired by executing fiber optic sensing (more specifically, DFOS) using the optical fiber cable 1 are hereinafter collectively referred to as “sensing data.” Specifically, when light is input to the optical fiber cable 1, the input light propagates through the optical fiber cable 1, and back scattering light is generated. By reception of the generated back scattering light, sensing data including fluctuations in amplitude and wavelength based on the vibration, the pressure, and the temperature of the generated back scattering light are acquired. More specifically, the vibration, the sound, and the temperature are acquired by analysis of fluctuations in the amplitude and the wavelength of the back scattering light. A predetermined physical quantity of the sensing data at each point is continuously acquired in an installation direction (that is, a longitudinal direction) of the optical fiber cable 1.

Specifically, for example, the sensing data may include vibration data acquired by executing distributed vibration sensing (DVS). Alternatively, for example, the sensing data may include acoustic data acquired by executing distributed acoustic sensing (DAS). Alternatively, for example, the sensing data may include temperature data acquired by executing distributed temperature sensing (DTS). An example of the sensing data including vibration data will be mainly described below. For example, the vibration data are data indicating a distribution of vibration strength for each frequency component in the installation direction (that is, the longitudinal direction) of the optical fiber cable 1.

An existing optical fiber cable for communication may be used as the optical fiber cable 1. Alternatively, a dedicated optical fiber cable installed for fiber optic sensing may be used as the optical fiber cable 1.

As illustrated in FIG. 2, a form of installation differs for each of sections S_1 to S_3 (each of the sections S_1 to S_3 may be hereinafter referred to as a section S) of the optical fiber cable 1. In other words, an environment of installation differs for each section S of the optical fiber cable 1. Such a form or environment may be hereinafter collectively referred to as an “installation environment.” In the example illustrated in FIG. 2, a predetermined section S_1 of 1 kilometer (may be hereinafter referred to as a “first section”) of the optical fiber cable 1 is buried underground. Another section S_2 of 2 kilometers (may be hereinafter referred to as a “second section”) of the optical fiber cable 1 is installed overhead by using a plurality of unillustrated utility poles. Another section S_3 of 3 kilometers (may be hereinafter referred to as a “third section”) of the optical fiber cable 1 is buried underground. The number of sections S is not limited to three. The installation environment in each section S is not limited to these specific examples.

Further, as illustrated in FIG. 2, an event being a target of detection by the event detection device 2 differs for each section S of the optical fiber cable 1. Such an event may be hereinafter referred to as a “detection target event.” In the example illustrated in FIG. 2, a detection target event in the first section S_1 is a break in the optical fiber cable 1. A detection target event in the second section S_2 is deterioration of each utility pole on which the optical fiber cable 1 is installed overhead. A detection target event in the third section S_3 is a break of the optical fiber cable 1 and vermin damage to the optical fiber cable 1 caused by a small animal (such as a rat). A detection target event in each section S is not limited to these specific examples.

As illustrated in FIG. 1, the event detection device 2 includes a sensing data acquisition unit 11, a detection unit 12, and an output control unit 13.

The sensing data acquisition unit 11 acquires sensing data by executing fiber optic sensing (more specifically, DFOS) using the optical fiber cable 1. For example, the sensing data acquisition unit 11 acquires vibration data executing DVS using the optical fiber cable 1.

In other words, the sensing data acquisition unit 11 includes a DFOS device (such as a DVS device). The sensing data acquisition unit 11 outputs a pulse-shaped optical signal. The output optical signal is input to an optical fiber in the optical fiber cable 1. The input optical signal propagates through the optical fiber. At this time, scattering of the propagating light occurs inside the optical fiber. A back scattering component out of optical components generated by such scattering is received by the sensing data acquisition unit 11. The sensing data acquisition unit 11 acquires sensing data (such as vibration data), based on the received back scattering component (that is, back scattering light).

The detection unit 12 detects occurrence of a detection target event related to each section S by using sensing data acquired by the sensing data acquisition unit 11. Specifically, for example, the detection unit 12 detects occurrence of a detection target event related to each of the first section S_1, the second section S_2, and the third section S_3 by using the acquired sensing data.

Specifically, as illustrated in FIG. 3, the detection unit 12 includes a first detection unit 21, a second detection unit 22, and a third detection unit 23. For example, the first detection unit 21 includes a dedicated artificial intelligence (AI) engine (may be hereinafter referred to as a “first AI engine”) for detecting occurrence of a break in the optical fiber cable 1. For example, the second detection unit 22 includes a dedicated AI engine (may be hereinafter referred to as a “second AI engine”) for detecting occurrence of deterioration of each utility pole. For example, the third detection unit 23 includes a dedicated AI engine (may be hereinafter referred to as a “third AI engine”) for detecting occurrence of vermin damage to the optical fiber cable 1 caused by a small animal. The AI engines are generated by advance machine learning.

The first detection unit 21 acquires data (may be hereinafter referred to as “first sensing data”) in sensing data acquired by the sensing data acquisition unit 11, the first sensing data being based on back scattering light generated in the first section S_1 (may be hereinafter referred to as “first back scattering light”). The first detection unit 21 detects a vibration pattern at each distance (that is, each point) in the first section S_1 by using vibration data included in the first sensing data. The vibration pattern may be a pattern indicating vibration strength with respect to frequency or a pattern indicating vibration strength with respect to time.

On the other hand, the first AI engine includes a model indicating a vibration pattern when a break at a related point is occurring or a vibration pattern when a break at the related point is not occurring. The first detection unit 21 compares the detected vibration pattern with the vibration pattern indicated by the model. In other words, the first detection unit 21 executes pattern matching using the vibration patterns. Consequently, whether a break has occurred in the first section S_1 is determined. Further, a position where the break has occurred in the first section S_1 is specified. Thus, occurrence of a break in the first section S_1 is detected.

Similarly, the first detection unit 21 acquires data (may be hereinafter referred to as “third sensing data”) in the sensing data acquired by the sensing data acquisition unit 11, the third sensing data being based on back scattering light generated in the third section S_3 (may be hereinafter referred to as “third back scattering light”). The first detection unit 21 detects a vibration pattern at each distance (that is, each point) in the third section S_3 by using vibration data included in the third sensing data. The first detection unit 21 compares the detected vibration pattern with the vibration pattern indicated by the model in the first AI engine. In other words, the first detection unit 21 executes pattern matching using the vibration patterns. Consequently, whether a break has occurred in the third section S_3 is determined. Further, a position where the break has occurred in the third section S_3 is specified. Thus, occurrence of a break in the third section S_3 is detected.

The second detection unit 22 acquires data (may be hereinafter referred to as “second sensing data”) in the sensing data acquired by the sensing data acquisition unit 11, the second sensing data being based on back scattering light generated in the second section S_2 (may be hereinafter referred to as “second back scattering light”). The second detection unit 22 detects a vibration pattern at each distance (that is, each point) in the second section S_2 by using vibration data included in the second sensing data. The vibration pattern may be a pattern indicating vibration strength with respect to frequency or a pattern indicating vibration strength with respect to time.

On the other hand, the second AI engine includes a model indicating a vibration pattern when deterioration of a utility pole at a related point is occurring or a vibration pattern when deterioration of a utility pole at the related point is not occurring. The second detection unit 22 compares the detected vibration pattern with the vibration pattern indicated by such a model. In other words, the second detection unit 22 executes pattern matching using the vibration patterns. Consequently, whether deterioration of each utility pole has occurred in the second section S_2 is determined. Thus, occurrence of deterioration of a utility pole in the second section S_2 is detected.

The third detection unit 23 acquires data (that is, the third sensing data) in the sensing data acquired by the sensing data acquisition unit 11, the third sensing data being based on the back scattering light generated in the third section S_3 (that is, third back scattering light). The third detection unit 23 detects a vibration pattern at each distance (that is, each point) in the third section S_3 by using vibration data included in the third sensing data. The vibration pattern may be a pattern indicating vibration strength with respect to frequency or a pattern indicating vibration strength with respect to time.

On the other hand, the third AI engine includes a model indicating a vibration pattern when vermin damage at a related point is occurring or a vibration pattern when vermin damage at the related point is not occurring. The third detection unit 23 compares the detected vibration pattern with the vibration pattern indicated by such a model. In other words, the third detection unit 23 executes pattern matching using the vibration patterns. Consequently, whether vermin damage has occurred in the third section S_3 is determined. Further, a position where the vermin damage has occurred in the third section S_3 is specified. Thus, occurrence of vermin damage in the third section S_3 is detected.

The number of detection units (21, 22, and 23) in the detection unit 12 is not limited to three. Such a number of detection units has only to be a number based on the types of detection target events. Further, a plurality of types of detection target events may be detected by a single detection unit (such as the detection unit 12).

The output control unit 13 executes control of outputting information about an event detected by the detection unit 12 (may be hereinafter referred to as “event information”) to the customer system 200. The output device 3 to be described later is used for output of the event information.

Specifically, for example, the event information includes information about a break in the optical fiber cable 1 in the first section S_1 (may be hereinafter referred to as “first event information”). Further, for example, the event information includes information about deterioration of a utility pole in the second section S_2 (may be hereinafter referred to as “second event information”). Further, for example, the event information includes information about a break in the optical fiber cable 1 in the third section S_3 (may be hereinafter referred to as “third event information”). Further, for example, the event information includes information about vermin damage to the optical fiber cable 1 in the third section S_3 (may be hereinafter referred to as “fourth event information”).

The output device 3 outputs event information to the customer system 200 under the control of the output control unit 13. Specifically, for example, the output device 3 includes a transceiver for wired communication or wireless communication. As described above, the output device 3 is communicable with the customer system 200 through the unillustrated network. The output device 3 transmits event information to the customer system 200 under the control of the output control unit 13.

The event detection system 100 is thus configured.

The customer system 200 is a system of a customer who purchases and uses event information. The customer system 200 may include a plurality of systems different from each other. Specifically, for example, the customer system 200 includes a first customer system 200_1, a second customer system 200_2, a third customer system 200_3, and a fourth customer system 200_4 as illustrated in FIG. 4.

The first customer system 200_1 is a system executing processing based on a state of occurrence of a break in the optical fiber cable 1 in the first section S_1. In other words, the first customer system 200_1 is a system providing a service based on such a state of occurrence of a break. Specifically, for example, the first customer system 200_1 is a system monitoring such a state of occurrence of a break and notifying a related customer of such a state of occurrence of a break.

In other words, the first customer system 200_1 is a system using the first event information. In this case, the control executed by the output control unit 13 includes control of outputting the first event information in event information to the first customer system 200_1. The output device 3 outputs the first event information to the first customer system 200_1 under such control.

The second customer system 200_2 is a system executing processing based on a state of occurrence of deterioration of a utility pole in the second section S_2. In other words, the second customer system 200_2 is a system providing a service based on such a state of occurrence of deterioration. Specifically, for example, the second customer system 200_2 is a system monitoring such a state of occurrence of deterioration and notifying a related customer of such a state of occurrence of deterioration.

In other words, the second customer system 200_2 is a system using the second event information. In this case, the control executed by the output control unit 13 includes control of outputting the second event information in event information to the second customer system 200_2. The output device 3 outputs the second event information to the second customer system 200_2 under such control.

The third customer system 200_3 is a system executing processing based on a state of occurrence of a break in the optical fiber cable 1 in the third section S_3. In other words, the third customer system 200_3 is a system providing a service based on such a state of occurrence of a break. Specifically, for example, the third customer system 200_3 is a system monitoring such a state of occurrence of a break and notifying a related customer of such a state of occurrence of a break.

In other words, the third customer system 200_3 is a system using the third event information. In this case, the control executed by the output control unit 13 includes control of outputting the third event information in event information to the third customer system 200_3. The output device 3 outputs the third event information to the third customer system 200_3 under such control.

The fourth customer system 200_4 is a system executing processing based on a state of occurrence of vermin damage to the optical fiber cable 1 in the third section S_3. In other words, the fourth customer system 200_4 is a system providing a service based on such a state of occurrence of vermin damage. Specifically, for example, the fourth customer system 200_4 is a system monitoring such a state of occurrence of vermin damage and notifying a related customer of such a state of occurrence of vermin damage.

In other words, the fourth customer system 200_4 is a system using the fourth event information. In this case, the control executed by the output control unit 13 includes control of outputting the fourth event information in event information to the fourth customer system 200_4. The output device 3 outputs the fourth event information to the fourth customer system 200_4 under such control.

The plurality of systems (200_1, 200_2, 200_3, and 200_4) included in the customer system 200 may be systems of customers identical to each other or systems of customers different from each other. Further, a customer related to at least one system out of the plurality of systems (200_1, 200_2, 200_3, and 200_4) may be a customer identical to a carrier providing the optical fiber cable 1. The number of systems included in the customer system 200 is not limited to four.

A multi-service is thus provided. Specifically, by using the single optical fiber cable 1, a different service is provided for each section S of the optical fiber cable 1.

The sensing data acquisition unit 11 may be hereinafter referred to as a “sensing data acquisition means.” The detection unit 12 may be referred to as a “detection means.” The output control unit 13 may be referred to as an “output control means.” The first detection unit 21 may be referred to as a “first detection means.” The second detection unit 22 may be referred to as a “second detection means.” The third detection unit 23 may be referred to as a “third detection means.”

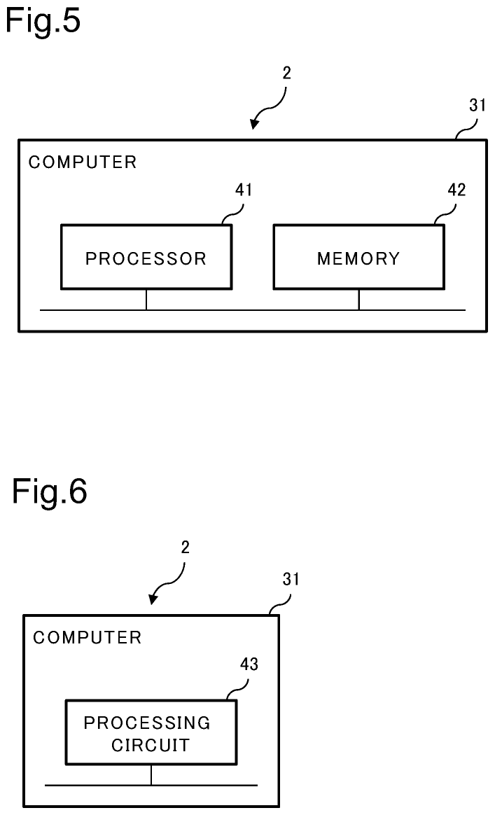

Next, a hardware configuration of the event detection device 2 will be described with reference to FIG. 5 to FIG. 7.

As illustrated in each of FIG. 5 to FIG. 7, the event detection device 2 uses a computer 31.

As illustrated in FIG. 5, the computer 31 includes a processor 41 and a memory 42. A program for causing the computer 31 to function as the sensing data acquisition unit 11, the detection unit 12, and the output control unit 13 is stored in the memory 42. The processor 41 reads and executes the program stored in the memory 42. Consequently, the function F1 of the sensing data acquisition unit 11, the function F2 of the detection unit 12, and the function F3 of the output control unit 13 are provided.

Alternatively, the computer 31 includes a processing circuit 43 as illustrated in FIG. 6. The processing circuit 43 executes processing for causing the computer 31 to function as the sensing data acquisition unit 11, the detection unit 12, and the output control unit 13. Consequently, the functions F1 to F3 are provided.

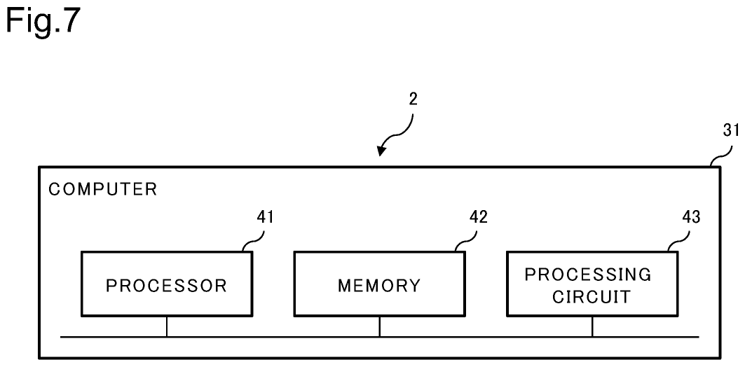

Alternatively, the computer 31 includes the processor 41, the memory 42, and the processing circuit 43 as illustrated in FIG. 7. In this case, part of the functions F1 to F3 is provided by the processor 41 and the memory 42. The remaining function out of the functions F1 to F3 is provided by the processing circuit 43.

The processor 41 includes one or more processors. For example, each processor uses a central processing unit (CPU), a graphics processing unit (GPU), a microprocessor, a microcontroller, or a digital signal processor (DSP).

The memory 42 includes one or more memories. Each memory uses a volatile memory or a nonvolatile memory. Specifically, for example, each memory uses a random-access memory (RAM), a read-only memory (ROM), a flash memory, an erasable programmable read-only memory (EPROM), an electrically erasable programmable read-only memory (EEPROM), a solid-state drive, a hard disk drive, a flexible disk, a compact disc, a digital versatile disc (DVD), a Blu-ray disc, a magneto-optical (MO) disk, or a minidisc.

The processing circuit 43 includes one or more processing circuits. For example, each processing circuit uses an application specific integrated circuit (ASIC), a programmable logic device (PLD), a field programmable gate array (FPGA), a system-on-a-chip (SoC), or a system large scale integration (LSI).

The processor 41 may include a dedicated processor related to each of the functions F1 to F3. The memory 42 may include a dedicated memory related to each of the functions F1 to F3. The processing circuit 43 may include a dedicated processing circuit related to each of the functions F1 to F3.

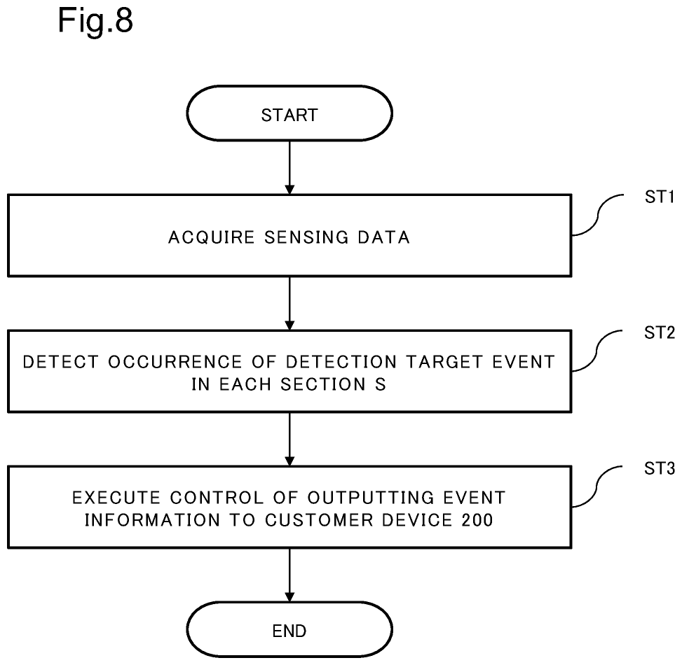

Next, the operation of the event detection system 100 will be described. More specifically, the operation of the event detection device 2 will be mainly described with reference to a flowchart illustrated in FIG. 8.

First, the sensing data acquisition unit 11 acquires sensing data by executing fiber optic sensing (more specifically, DFOS) using the optical fiber cable 1 (Step ST1). Specific examples of sensing data have been already described. Therefore, duplicated description is omitted.

Next, the detection unit 12 detects occurrence of a detection target event in each section S by using the acquired sensing data (Step ST2). Specific examples of a detection target event in each section S have been already described. Therefore, duplicated description is omitted.

Next, the output control unit 13 executes control of outputting information about the detected event (that is, event information) to the customer system 200 (Step ST3). Specific examples of event information and a specific example of the customer system 200 have been already described. Therefore, duplicated description is omitted.

Next, a modified example of the event detection system 100 will be described.

Two sections S adjacent to each other in a plurality of sections S may not overlap each other (see FIG. 2). Alternatively, the two sections S may at least partially overlap each other. In other words, a section S being a unit of detection by the event detection device 2 may not necessarily be related to an installation environment of the optical fiber cable 1. For example, it is assumed that a target of detection in a section (S_4) being one part of a section in which the optical fiber cable 1 is buried is vermin damage and a target of detection in a section (S_5) being another part of the buried section is a break. At this time, the sections (S_4 and S_5) may partially overlap each other.

The number of sections S is not limited to three. The number of sections S has only to be two or more. Consequently, a multi-service can be provided.

A detection target event in each section S is not limited to the specific examples described above (deterioration of a utility pole, a break, and vermin damage). An event detection target in each section S may be any event as long as the event is detected by using vibration data, acoustic data, or temperature data based on DFOS.

The customer system 200 is not limited to the specific example described above. The customer system 200 may be any system as long as the system uses event information related to one of the sections S.

In other words, the correspondence between the customer system 200 and a section S is not limited to the specific example described above. Each customer system 200 has only to use event information related to one or more sections S out of a plurality of sections S. Further, the correspondence between the customer system 200 and a detection target event is not limited to the specific example described above. Each customer system 200 may use event information related to any detection target event (that is, event information related to any section S). Further, the correspondence between the customer system 200 and a customer is not limited to the specific example described above. Each customer system 200 may be shared by two or more customers. Further, each customer may use two or more customer systems 200.

The detection unit 12 is not limited to the specific example illustrated in FIG. 3. For example, when the third section S_3 does not exist or when a detection target event in the third section S_3 does not include vermin damage, the first detection unit 21 and the third detection unit 23 may constitute the detection unit 12. In other words, the event detection device 2 may include the first detection unit 21 and the second detection unit 22 in such a case.

The event detection system 100 may have a function of managing a usage fee of related event information used by each customer (hereinafter referred to as a “fee management function”). The fee management function may be provided in the event detection device 2. The fee management function may include a function of calculating a usage fee of related event information used by each customer (hereinafter referred to as a “fee calculation function”). For example, the fee calculation function may acquire at least one type of information out of (i) to (iv) below and calculate a usage fee by using the acquired information.
(i) information indicating the section length of a section S to be used
(ii) information indicating the unit usage price of a service (a customer system) to be used
(iii) information indicating the usage period of a service (a customer system) to be used
(iv) information indicating a discount rate based on the number of services (customer systems) to be used

Specifically, for example, the fee calculation function calculates a usage fee, based on Equation (1) below. R denotes a usage fee, α denotes a section length, β denotes a unit usage price, γ denotes a usage period, and δ denotes a discount rate.

$$R = \sum ( α \times β \times γ ) \times δ \qquad ( 1 )$$

Next, effects of the event detection system 100 will be described.

As described above, the sensing data acquisition unit 11 acquires sensing data (such as vibration data) by executing fiber optic sensing (more specifically, DFOS) using the optical fiber cable 1. The first detection unit 21 detects occurrence of a first event (such as a break) in the first section S_1 of the optical fiber cable 1 by using first sensing data in the sensing data, the first sensing data being based on first back scattering light generated in the first section S_1. The second detection unit 22 detects occurrence of a second event (such as deterioration of a utility pole) in the second section S_2 of the optical fiber cable 1 by using second sensing data in the sensing data, the second sensing data being based on second back scattering light generated in the second section S_2. A multi-service can be provided based on the result of the detections. In other words, a different service based on fiber optic sensing can be provided for each section S of the single optical fiber cable 1.

The installation environment of the optical fiber cable 1 in the first section S_1 (such as underground burial) is different from the installation environment of the optical fiber cable 1 in the second section S_2 (such as overhead installation). Consequently, a multi-service in a plurality of sections S related to installation environments different from each other can be provided.

The first event (such as a break) is different from the second event (such as deterioration of a utility pole). Consequently, a multi-service based on a plurality of types of detection target items different from each other can be provided.

The first section S_1 at least partially overlaps the second section S_2. Even in such a case, a multi-service can be provided.

Fiber optic sensing is distributed fiber optic sensing (DFOS). Consequently, a multi-service using DFOS can be provided.

Each of the first detection unit 21 and the second detection unit 22 includes an AI engine. Consequently, for example, detection in each of the first detection unit 21 and the second detection unit 22 can be achieved by pattern matching between a pattern indicated by sensing data and a pattern indicated by a model in the AI engine.

Information about the first event (the first event information) detected by the first detection unit 21 is output to the first customer system 200_1. Information about the second event (the second event information) detected by the second detection unit 22 is output to the second customer system 200_2. Consequently, event information used in each service in a multi-service can be output to a related customer system 200.

### Second Example Embodiment

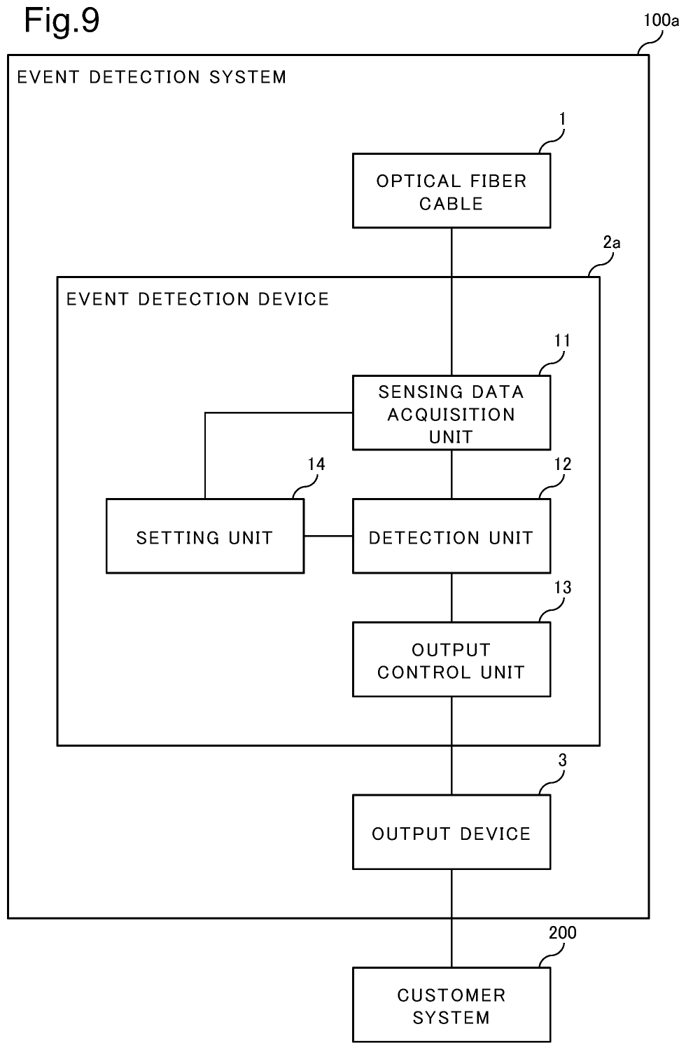

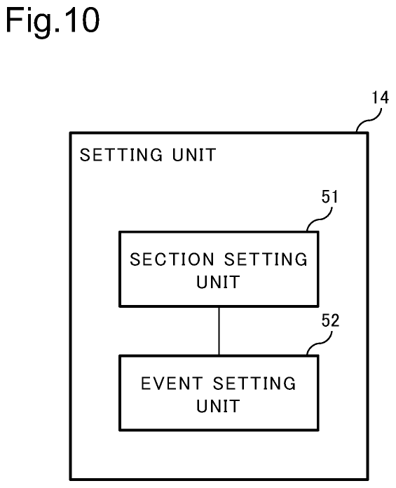

FIG. 9 is a block diagram illustrating an event detection system according to a second example embodiment. FIG. 10 is a block diagram illustrating an example of a setting unit in an event detection device according to the second example embodiment. The event detection system according to the second example embodiment will be described with reference to FIG. 9 and FIG. 10. In FIG. 9, a block similar to a block illustrated in FIG. 1 is given the same sign, and description is omitted.

As illustrated in FIG. 9, the event detection system 100a includes an optical fiber cable 1, an event detection device 2a, and an output device 3. The event detection device 2a includes a sensing data acquisition unit 11, a detection unit 12, and an output control unit 13. In addition, the event detection device 2a includes a setting unit 14. As illustrated in FIG. 10, the setting unit 14 includes a section setting unit 51 and an event setting unit 52.

The section setting unit 51 sets each section S. The event setting unit 52 sets a detection target event in each of the set sections S. The detection unit 12 detects occurrence of a related detection target event in each section S, based on the settings.

The section setting unit 51 may set a predetermined section to each section S, based on the distance from the sensing data acquisition unit 11 on the optical fiber cable 1. Alternatively, the section setting unit 51 may set a section indicated by information input by a person (such as an operator of the event detection system 100) to each section S, based on such a distance. Alternatively, the section setting unit 51 may detect installation information of the optical fiber cable 1 and set a section based on the detected installation environment to each section S.

Specifically, in a state in which no detection target event is occurring (may be hereinafter referred to as a “natural state”), an environment around the optical fiber cable 1 (such as vibration, sound, and temperature) varies by an installation environment of the cable (such as overhead installation or underground burial). Therefore, a pattern indicated by sensing data (such as a vibration pattern) in the natural state varies by the installation environment.

Then, information indicating a pattern related to each installation environment in the natural state (may be hereinafter referred to as a “model pattern”) is previously stored in the section setting unit 51. The section setting unit 51 compares a pattern indicated by sensing data at each distance (that is, each point) acquired by the sensing data acquisition unit 11 with each model pattern. Consequently, the section setting unit 51 detects a section related to each installation environment. The section setting unit 51 sets the detected section to each section S.

Specifically, for example, the section setting unit 51 determines that an installation environment of a section related to a distance range of 0 kilometers (km) to 1 km relative to the installation position of the sensing data acquisition unit 11 on the optical fiber cable 1 illustrated in FIG. 2 is underground burial. The section setting unit 51 sets such a section to a first section S_1. Similarly, the section setting unit 51 determines that an installation environment of a section related to a distance range of 1 km to 3 km is overhead installation using utility poles. The section setting unit 51 sets such a section to a second section S_2. Similarly, the section setting unit 51 determines that an installation environment of a section related to a distance range of 3 km to 6 km is underground burial. The section setting unit 51 sets such a section to a third section S_3.

The event setting unit 52 may set an event related to the detected installation environment to a detection target event for each of the set sections S.

For example, information indicating a detection target event (such as a break, vermin damage, or deterioration) related to each installation environment (such as underground burial or overhead installation) is previously stored in the event setting unit 52. By using such information, the event setting unit 52 sets an event related to the installation environment to a detection target event for each of the set sections S.

Specifically, for example, it is assumed that the first section S_1, the second section S_2, and the third section S_3 that are illustrated in FIG. 2 are set by the section setting unit 51. It is further assumed in the information previously stored in the event setting unit 52 that a detection target event related to a section in which the cable is installed overhead by using a plurality of utility poles is deterioration of each utility pole and a detection target event related to a section in which the cable is buried underground is at least one item out of a break and vermin damage.

In this case, since the detected installation environment for the second section S_2 is underground burial using a plurality of utility poles, the event setting unit 52 sets deterioration of each utility pole to a detection target event. Further, since the detected installation environment is underground burial for each of the first section S_1 and the third section S_3, the event setting unit 52 sets at least one item out of a break and vermin damage to a detection target event.

The event detection system 100a is thus configured.

The setting unit 14 may be hereinafter referred to as a “setting means.” The section setting unit 51 may be referred to as a “section setting means.” The event setting unit 52 may be referred to as an “event setting means.”

A hardware configuration of the event detection device 2a is similar to that described with reference to FIG. 5 to FIG. 7 in the first example embodiment. Therefore, detailed description is omitted. Specifically, the event detection device 2a has the function F1 of the sensing data acquisition unit 11, the function F2 of the detection unit 12, the function F3 of the output control unit 13, and the function F4 of the setting unit 14. Each of the functions F1 to F4 may be provided by a processor 41 and a memory 42 or may be provided by a processing circuit 43.

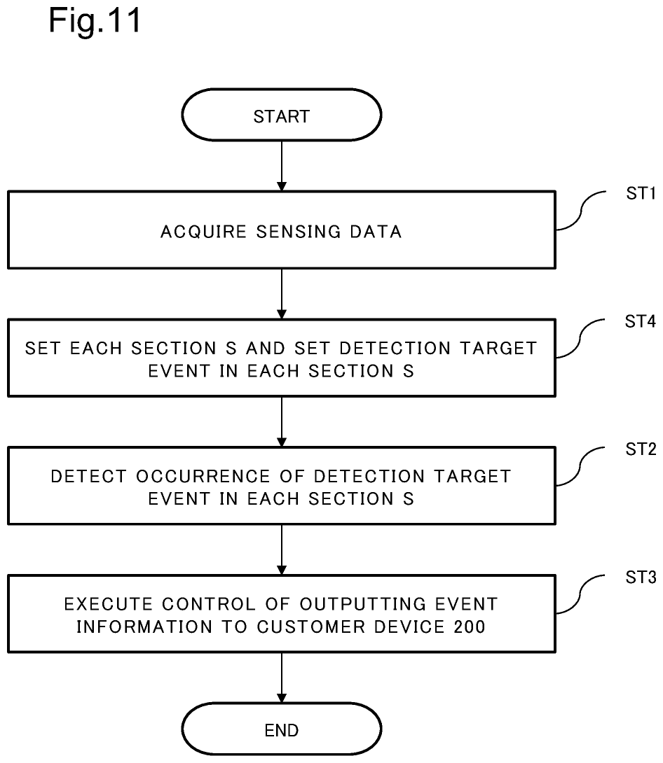

Next, the operation of the event detection system 100a will be described. More specifically, the operation of the event detection device 2a will be mainly described with reference to a flowchart illustrated in FIG. 11. In FIG. 11, a step similar to a step described in FIG. 8 is given the same sign, and description is omitted.

First, the sensing data acquisition unit 11 acquires sensing data (Step ST1).

Next, the setting unit 14 sets each section S and sets a detection target event in each section S (Step ST4). At this time, as described above, the setting unit 14 (more specifically, the section setting unit 51) may detect an installation environment of the optical fiber cable 1 and set each section S, based on the detected installation environment. Further, the setting unit 14 (more specifically, the event setting unit 52) may set an event related to the detected installation environment to a detection target event for each section S.

Next, the detection unit 12 detects occurrence of a detection target event in each section S (Step ST2). Next, the output control unit 13 executes control of outputting event information to a customer system 200 (Step ST3).

Next, a modified example of the event detection system 100a will be described.

The event detection system 100a may employ various modified examples similar to those described in the first example embodiment. In addition, the event detection system 100a may employ modified examples as described below.

The event setting unit 52 may detect an installation environment of the optical fiber cable 1 instead of the section setting unit 51 detecting an installation environment of the optical fiber cable 1. In this case, the section setting unit 51 may set each section S, based on the installation environment detected by the event setting unit 52.

The setting unit 14 may include either one of the section setting unit 51 and the event setting unit 52 instead of including both the section setting unit 51 and the event setting unit 52. In other words, the event detection device 2a may include either one of the section setting unit 51 and the event setting unit 52 instead of including both the section setting unit 51 and the event setting unit 52.

When the event detection device 2a includes only the event setting unit 52 out of the section setting unit 51 and the event setting unit 52, the event setting unit 52 may detect an installation environment of the optical fiber cable 1 in each section S by using sensing data related to the section S and set an event related to the detected installation environment to a detection target event.

For example, the event setting unit 52 detects that the installation environment of the optical fiber cable 1 in the first section S_1 is underground burial by using first sensing data. The event setting unit 52 sets an event related to the detected installation environment (such as at least one item out of a break and vermin damage) to a detection target event in the first section S_1. Further, the event setting unit 52 detects that the installation environment of the optical fiber cable 1 in the second section S_2 is overhead installation using a plurality of utility poles by using second sensing data. The event setting unit 52 sets an event related to the detected installation environment (such as deterioration of a utility pole) to a detection target event in the second section S_2.

Next, effects of the event detection system 100a will be described.

The event detection system 100a provides effects similar to those described in the first example embodiment. In addition, the event detection system 100a provides effects as described below.

Specifically, the section setting unit 51 sets the first section S_1 and the second section S_2, based on the installation environment of the optical fiber cable 1, by using sensing data. Use of the sensing data enables detection of the installation environment of the optical fiber cable 1. Use of the result of such detection enables setting of each section S (including the first section S_1 and the second section S_2) based on such an installation environment even when the installation environment of the optical fiber cable 1 is unknown in the event detection system 100a. In other words, the need for advance preparation of information indicating an installation environment can be eliminated in setting of each section S.

The event setting unit 52 sets an event related to the installation environment of the optical fiber cable 1 in the first section S_1 to the first event by using first sensing data. The event setting unit 52 sets an event related to the installation environment of the optical fiber cable 1 in the second section S_2 to the second event by using second sensing data. Use of the sensing data enables detection of the installation environment of the optical fiber cable 1. Use of the result of such detection enables setting of an event related to such an installation environment to a detection target event in each section S (including the first section S_1 and the second section S_2) even when the installation environment of the optical fiber cable 1 is unknown in the event detection system 100a. In other words, the need for advance preparation of information indicating an installation environment can be eliminated in setting of a detection target event in each section S.

### Third Example Embodiment

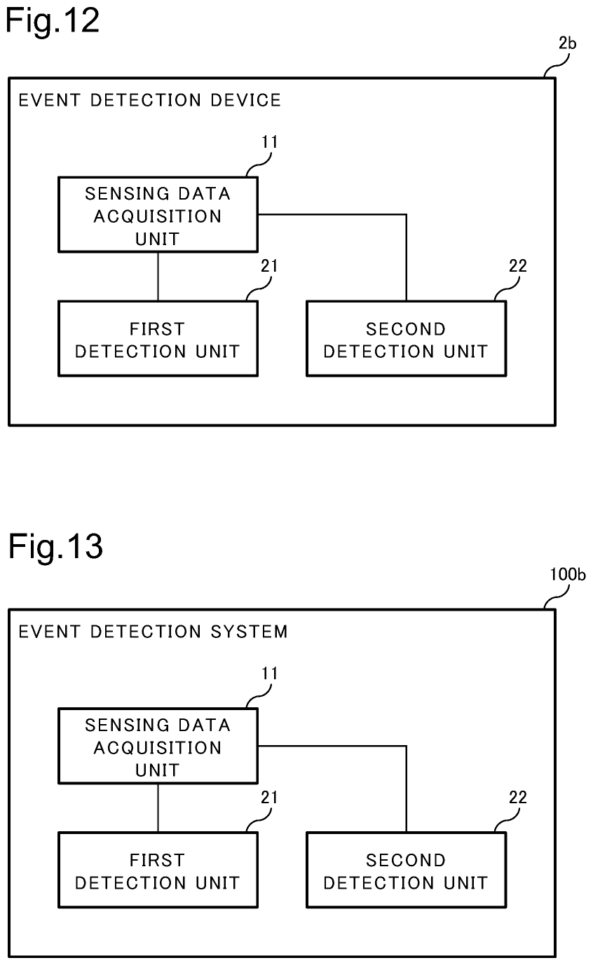

FIG. 12 is a block diagram illustrating an event detection device according to a third example embodiment. The event detection device according to the third example embodiment will be described with reference to FIG. 12. FIG. 13 is a block diagram illustrating an event detection system according to the third example embodiment. The event detection system according to the third example embodiment will be described with reference to FIG. 13. In each of FIG. 12 and FIG. 13, a block similar to a block illustrated in FIG. 1 and FIG. 3 is given the same sign, and description is omitted.

The event detection device according to each of the first example embodiment and the second example embodiment is an example of the event detection device according to the third example embodiment. The event detection system according to each of the first example embodiment and the second example embodiment is an an example of the event detection system according to the third example embodiment.

As illustrated in FIG. 12, the event detection device 2b includes a sensing data acquisition unit 11, a first detection unit 21, and a second detection unit 22. In this case, an output control unit 13 may be provided outside the event detection device 2b.

As illustrated in FIG. 13, the event detection system 100b includes the sensing data acquisition unit 11, the first detection unit 21, and the second detection unit 22. In this case, an optical fiber cable 1 may be provided outside the event detection system 100b. Further, the output control unit 13 may be provided outside the event detection system 100b. Further, an output device 3 may be provided outside the event detection system 100b.

Even in these cases, effects similar to those described in the first example embodiment are acquired.

Specifically, the sensing data acquisition unit 11 acquires sensing data by executing fiber optic sensing using the optical fiber cable 1. The first detection unit 21 detects occurrence of a first event in a first section S_1 of the optical fiber cable 1 by using first sensing data in the sensing data, the first sensing data being based on first back scattering light generated in the first section S_1. The second detection unit 22 detects occurrence of a second event in a second section S_2 of the optical fiber cable 1 by using second sensing data in the sensing data, the second sensing data being based on second back scattering light generated in the second section S_2. A multi-service can be provided based on the result of the detections. In other words, a different service based on fiber optic sensing can be provided for each section S of the single optical fiber cable 1.

The event detection device 2b may include at least one of a section setting unit 51 and an event setting unit 52. Further, the event detection system 100b may include at least one of the section setting unit 51 and the event setting unit 52. Further, the event detection system 100b may include the output control unit 13.

Each unit in the event detection system 100b may be configured with an independent device. The devices may be placed in a distributed manner geographically or network-wise. For example, the devices may include an edge computer and a cloud computer.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above may also be described as, but not limited to, the following Supplementary Notes.

### SUPPLEMENTARY NOTES

### Supplementary Note 1

An event detection device including:
a sensing data acquisition means for acquiring sensing data by executing fiber optic sensing using an optical fiber cable;
a first detection means for detecting occurrence of a first event in a first section of the optical fiber cable by using first sensing data in the sensing data, the first sensing data being based on first back scattering light generated in the first section; and
a second detection means for detecting occurrence of a second event in a second section of the optical fiber cable by using second sensing data in the sensing data, the second sensing data being based on second back scattering light generated in the second section.

### Supplementary Note 2

The event detection device according to Supplementary Note 1, further including
a section setting means for setting the first section and the second section, based on an installation environment of the optical fiber cable, by using the sensing data.

### Supplementary Note 3

The event detection device according to Supplementary Note 1 or 2, further including
an event setting means for setting an event related to an installation environment of the optical fiber cable in the first section to the first event by using the first sensing data and setting an event related to an installation environment of the optical fiber cable in the second section to the second event by using the second sensing data.

### Supplementary Note 4

The event detection device according to any one of Supplementary Notes 1 to 3, wherein
an installation environment of the optical fiber cable in the first section is different from an installation environment of the optical fiber cable in the second section.

### Supplementary Note 5

The event detection device according to any one of Supplementary Notes 1 to 4, wherein
the first event is different from the second event.

### Supplementary Note 6

The event detection device according to any one of Supplementary Notes 1 to 5, wherein
the first section at least partially overlaps the second section.

### Supplementary Note 7

The event detection device according to any one of Supplementary Notes 1 to 6, wherein
the fiber optic sensing is distributed fiber optic sensing.

### Supplementary Note 8

The event detection device according to any one of Supplementary Notes 1 to 7, wherein
at least one of the first detection means and the second detection means includes an AI engine.

### Supplementary Note 9

The event detection device according to any one of Supplementary Notes 1 to 8, wherein
information about the first event detected by the first detection means is output to a first customer system, and information about the second event detected by the second detection means is output to a second customer system.

### Supplementary Note 10

An event detection system including:
a sensing data acquisition means for acquiring sensing data by executing fiber optic sensing using an optical fiber cable;
a first detection means for detecting occurrence of a first event in a first section of the optical fiber cable by using first sensing data in the sensing data, the first sensing data being based on first back scattering light generated in the first section; and
a second detection means for detecting occurrence of a second event in a second section of the optical fiber cable by using second sensing data in the sensing data, the second sensing data being based on second back scattering light generated in the second section.

### Supplementary Note 11

The event detection system according to Supplementary Note 10, further including
a section setting means for setting the first section and the second section, based on an installation environment of the optical fiber cable, by using the sensing data.

### Supplementary Note 12

The event detection system according to Supplementary Note 10 or 11, further including
an event setting means for setting an event related to an installation environment of the optical fiber cable in the first section to the first event by using the first sensing data and setting an event related to an installation environment of the optical fiber cable in the second section to the second event by using the second sensing data.

### Supplementary Note 13

The event detection system according to any one of Supplementary Notes 10 to 12, wherein
an installation environment of the optical fiber cable in the first section is different from an installation environment of the optical fiber cable in the second section.

### Supplementary Note 14

The event detection system according to any one of Supplementary Notes 10 to 13, wherein
the first event is different from the second event.

### Supplementary Note 15

The event detection system according to any one of Supplementary Notes 10 to 14, wherein
the first section at least partially overlaps the second section.

### Supplementary Note 16

The event detection system according to any one of Supplementary Notes 10 to 15, wherein
the fiber optic sensing is distributed fiber optic sensing.

### Supplementary Note 17

The event detection system according to any one of Supplementary Notes 10 to 16, wherein
at least one of the first detection means and the second detection means includes an AI engine.

### Supplementary Note 18

The event detection system according to any one of Supplementary Notes 10 to 17, wherein
information about the first event detected by the first detection means is output to a first customer system, and information about the second event detected by the second detection means is output to a second customer system.

### Supplementary Note 19

An event detection method including:
by a sensing data acquisition means, acquiring sensing data by executing fiber optic sensing using an optical fiber cable;
by a first detection means, detecting occurrence of a first event in a first section of the optical fiber cable by using first sensing data in the sensing data, the first sensing data being based on first back scattering light generated in the first section; and,
by a second detection means, detecting occurrence of a second event in a second section of the optical fiber cable by using second sensing data in the sensing data, the second sensing data being based on second back scattering light generated in the second section.

### Supplementary Note 20

The event detection method according to Supplementary Note 19, further including,
by a section setting means, setting the first section and the second section, based on an installation environment of the optical fiber cable, by using the sensing data.

### Supplementary Note 21

The event detection method according to Supplementary Note 19 or 20, further including,
by an event setting means, setting an event related to an installation environment of the optical fiber cable in the first section to the first event by using the first sensing data and setting an event related to an installation environment of the optical fiber cable in the second section to the second event by using the second sensing data.

### Supplementary Note 22

The event detection method according to any one of Supplementary Notes 19 to 21, wherein
an installation environment of the optical fiber cable in the first section is different from an installation environment of the optical fiber cable in the second section.

### Supplementary Note 23

The event detection method according to any one of Supplementary Notes 19 to 22, wherein
the first event is different from the second event.

### Supplementary Note 24

The event detection method according to any one of Supplementary Notes 19 to 23, wherein
the first section at least partially overlaps the second section.

### Supplementary Note 25

The event detection method according to any one of Supplementary Notes 19 to 24, wherein
the fiber optic sensing is distributed fiber optic sensing.

### Supplementary Note 26

The event detection method according to any one of Supplementary Notes 19 to 25, wherein
at least one of the first detection means and the second detection means includes an AI engine.

### Supplementary Note 27

The event detection method according to any one of Supplementary Notes 19 to 26, wherein
information about the first event detected by the first detection means is output to a first customer system, and information about the second event detected by the second detection means is output to a second customer system.

### Supplementary Note 28

A recording medium on which a program is recorded, the program causing a computer to function as:
a sensing data acquisition means for acquiring sensing data by executing fiber optic sensing using an optical fiber cable;
a first detection means for detecting occurrence of a first event in a first section of the optical fiber cable by using first sensing data in the sensing data, the first sensing data being based on first back scattering light generated in the first section; and
a second detection means for detecting occurrence of a second event in a second section of the optical fiber cable by using second sensing data in the sensing data, the second sensing data being based on second back scattering light generated in the second section.

### Supplementary Note 29

The recording medium according to Supplementary Note 28, wherein the program further causes the computer to function as
a section setting means for setting the first section and the second section, based on an installation environment of the optical fiber cable, by using the sensing data.

### Supplementary Note 30

The recording medium according to Supplementary Note 28 or 29, wherein the program further causes the computer to function as
an event setting means for setting an event related to an installation environment of the optical fiber cable in the first section to the first event by using the first sensing data and setting an event related to an installation environment of the optical fiber cable in the second section to the second event by using the second sensing data.

### Supplementary Note 31

The recording medium according to any one of Supplementary Notes 28 to 30, wherein
an installation environment of the optical fiber cable in the first section is different from an installation environment of the optical fiber cable in the second section.

### Supplementary Note 32

The recording medium according to any one of Supplementary Notes 28 to 31, wherein
the first event is different from the second event.

### Supplementary Note 33

The recording medium according to any one of Supplementary Notes 28 to 32, wherein
the first section at least partially overlaps the second section.

### Supplementary Note 34

The recording medium according to any one of Supplementary Notes 28 to 33, wherein
the fiber optic sensing is distributed fiber optic sensing.

### Supplementary Note 35

The recording medium according to any one of Supplementary Notes 28 to 34, wherein
at least one of the first detection means and the second detection means includes an AI engine.

### Supplementary Note 36

The recording medium according to any one of Supplementary Notes 28 to 35, wherein the program further causes the computer to function as
an output control means for executing control of outputting information about the first event detected by the first detection means to a first customer system and control of outputting information about the second event detected by the second detection means to a second customer system.

### REFERENCE SIGNS LIST

1 Optical fiber cable
2, 2a, 2b Event detection device
3 Output device
11 Sensing data acquisition unit
12 Detection unit
13 Output control unit
14 Setting unit
21 First detection unit
22 Second detection unit
23 Third detection unit
31 Computer
41 Processor
42 Memory
43 Processing circuit
51 Section setting unit
52 Event setting unit
100, 100a, 100b Event detection system
200 Customer system
200_1 First customer system
200_2 Second customer system
200_3 Third customer system
200_4 Fourth customer system

What is claimed is:

1. An event detection device comprising:
one or more memories storing instructions; and
one or more processors configured to execute the instructions to:
acquire sensing data by executing fiber optic sensing using an optical fiber cable;
detect occurrence of a first event in a first section of the optical fiber cable by using first sensing data in the sensing data, the first sensing data being based on first back scattering light generated in the first section; and
detect occurrence of a second event in a second section of the optical fiber cable by using second sensing data in the sensing data, the second sensing data being based on second back scattering light generated in the second section.

2. The event detection device according to claim 1,
wherein the one or more processors are configured to further execute the instructions to set the first section and the second section, based on an installation environment of the optical fiber cable, by using the sensing data.

3. The event detection device according to claim 1, wherein the one or more processors are configured to further execute the instructions to:
set an event related to an installation environment of the optical fiber cable in the first section to the first event by using the first sensing data; and
set an event related to an installation environment of the optical fiber cable in the second section to the second event by using the second sensing data.

4. The event detection device according to claim 1, wherein
an installation environment of the optical fiber cable in the first section is different from an installation environment of the optical fiber cable in the second section.

5. The event detection device according to claim 1, wherein
the first event is different from the second event.

6. The event detection device according to claim 1, wherein
the first section at least partially overlaps the second section.

7. The event detection device according to claim 1, wherein
the fiber optic sensing is distributed fiber optic sensing.

8. The event detection device according to claim 1, wherein
at least one of the first event and the second event includes an AI engine.

9. The event detection device according to claim 1, wherein
information about the first event is output to a first customer system, and information about the second event is output to a second customer system.

10. An event detection system comprising:
one or more memories storing instructions; and
one or more processors configured to execute the instructions to:
acquire sensing data by executing fiber optic sensing using an optical fiber cable;
detect occurrence of a first event in a first section of the optical fiber cable by using first sensing data in the sensing data, the first sensing data being based on first back scattering light generated in the first section; and
detect occurrence of a second event in a second section of the optical fiber cable by using second sensing data in the sensing data, the second sensing data being based on second back scattering light generated in the second section.

11. The event detection system according to claim 10,
wherein the one or more processors are configured to further execute the instructions to set the first section and the second section, based on an installation environment of the optical fiber cable, by using the sensing data.

12. The event detection system according to claim 10,
wherein the one or more processors are configured to further execute the instructions to:
set an event related to an installation environment of the optical fiber cable in the first section to the first event by using the first sensing data; and
set an event related to an installation environment of the optical fiber cable in the second section to the second event by using the second sensing data.

13. The event detection system according to claim 10, wherein
an installation environment of the optical fiber cable in the first section is different from an installation environment of the optical fiber cable in the second section.

14. The event detection system according to claim 10, wherein
the first event is different from the second event.

15. The event detection system according to claim 10, wherein
the first section at least partially overlaps the second section.

16. The event detection system according to claim 10, wherein
the fiber optic sensing is distributed fiber optic sensing.

17. The event detection system according to claim 10, wherein
at least one of the first detection means and the second detection means includes an AI engine.

18. The event detection system according to claim 10, wherein
information about the first event is output to a first customer system, and information about the second event is output to a second customer system.

19. An event detection method comprising:
by a computer,
acquiring sensing data by executing fiber optic sensing using an optical fiber cable;
detecting occurrence of a first event in a first section of the optical fiber cable by using first sensing data in the sensing data, the first sensing data being based on first back scattering light generated in the first section; and,
detecting occurrence of a second event in a second section of the optical fiber cable by using second sensing data in the sensing data, the second sensing data being based on second back scattering light generated in the second section.

20. The event detection method according to claim 19, further comprising,
by a computer, setting the first section and the second section, based on an installation environment of the optical fiber cable, by using the sensing data.

21.-27. (canceled)
